(19) United States
(12) Patent Application Publication
(10) Pub. No.: US 2018/0120746 A1
(43) Pub. Date: May 3, 2018

(54) IMAGE FORMING METHOD AND IMAGE FORMING APPARATUS

(71) Applicant: FUJI XEROX CO., LTD., Tokyo (JP)

(72) Inventor: Shigeru ARAI, Kanagawa (JP)

(73) Assignee: FUJI XEROX CO., LTD., Tokyo (JP)

(21) Appl. No.: 15/794,751

(22) Filed: Oct. 26, 2017

(30) Foreign Application Priority Data
Oct. 28, 2016 (JP) 2016-212061

(51) Int. Cl. G06F 3/12

(52) U.S. Cl. CPC G03G 15/5062

(57) ABSTRACT

An image forming method includes performing image correction on a region where an image is to be corrected by using correction information set based on a development condition, the region being determined based on a density difference in the image to be formed.

### CROSS-REFERENCE TO RELATED APPLICATIONS

This application is based on and claims priority under 35 USC 119 from Japanese Patent Application No. 2016-212061 filed Oct. 28, 2016.

### BACKGROUND

### Technical Field

The present invention relates to image forming methods and image forming apparatuses.

### SUMMARY

According to an aspect of the invention, there is provided an image forming method including performing image correction on a region where an image is to be corrected by using correction information set based on a development condition, the region where the image is to be corrected being determined based on a density difference in the image to be formed.

### BRIEF DESCRIPTION OF THE DRAWINGS

An exemplary embodiment of the present invention will be described in detail based on the following figures, wherein:

FIG. 1 is an overall view of an image forming apparatus according to a first exemplary embodiment of the present invention;

FIG. 2 illustrates a relevant part of the image forming apparatus according to the first exemplary embodiment of the present invention;

FIG. 3 is a block diagram illustrating functions included in a controller of the image forming apparatus according to the first exemplary embodiment;

FIG. 4 illustrates a table of correction factors used for correcting a density correction value based on development conditions in accordance with the first exemplary embodiment;

FIGS. 5A to 5C illustrate a mechanism of how trail edge deletion (TED) occurs, FIG. 5A illustrating a state where an image portion is passing through a developing region, FIG. 5B illustrating a state where a blank portion (i.e., a background image portion) is passing through the developing region, FIG. 5C illustrating a state where TED has occurred;

FIGS. 6A to 6C illustrate a mechanism of how starvation (STV) occurs, FIG. 6A illustrating a state where a halftone image portion is passing through the developing region, FIG. 6B illustrating a state where a solid image portion is passing through the developing region, FIG. 6C illustrating a state where STV has occurred;

FIG. 7 illustrates an image to be used when deriving basic correction information according to the first exemplary embodiment;

FIGS. 8A and 8B illustrate existing basic correction information according to the first exemplary embodiment, FIG. 8A being a graph showing basic correction information for TED, FIG. 8B being a graph showing basic correction information for STV;

FIG. 9 illustrates a flowchart of a basic-correction-information setting process according to the first exemplary embodiment; and

FIG. 10 illustrates a flowchart of a correction-information setting process according to the first exemplary embodiment.

### DETAILED DESCRIPTION

Although a specific exemplary embodiment of the present invention will be described below with reference to the drawings, the present invention is not to be limited to the following exemplary embodiment.

In order to provide an easier understanding of the following description, the front-rear direction will be defined as “X-axis direction” in the drawings, the left-right direction will be defined as “Y-axis direction”, and the up-down direction will be defined as “Z-axis direction”. Moreover, the directions or the sides indicated by arrows X, −X, Y, −Y, Z, and −Z are defined as forward, rearward, rightward, leftward, upward, and downward directions, respectively, or as front, rear, right, left, upper, and lower sides, respectively.

Furthermore, in each of the drawings, a circle with a dot in the center indicates an arrow extending from the far side toward the near side of the plane of the drawing, and a circle with an “x” therein indicates an arrow extending from the near side toward the far side of the plane of the drawing.

In the drawings used for explaining the following description, components other than those for providing an easier understanding of the description are omitted where appropriate.

### First Exemplary Embodiment

Overall Configuration of Printer U According to First Exemplary Embodiment

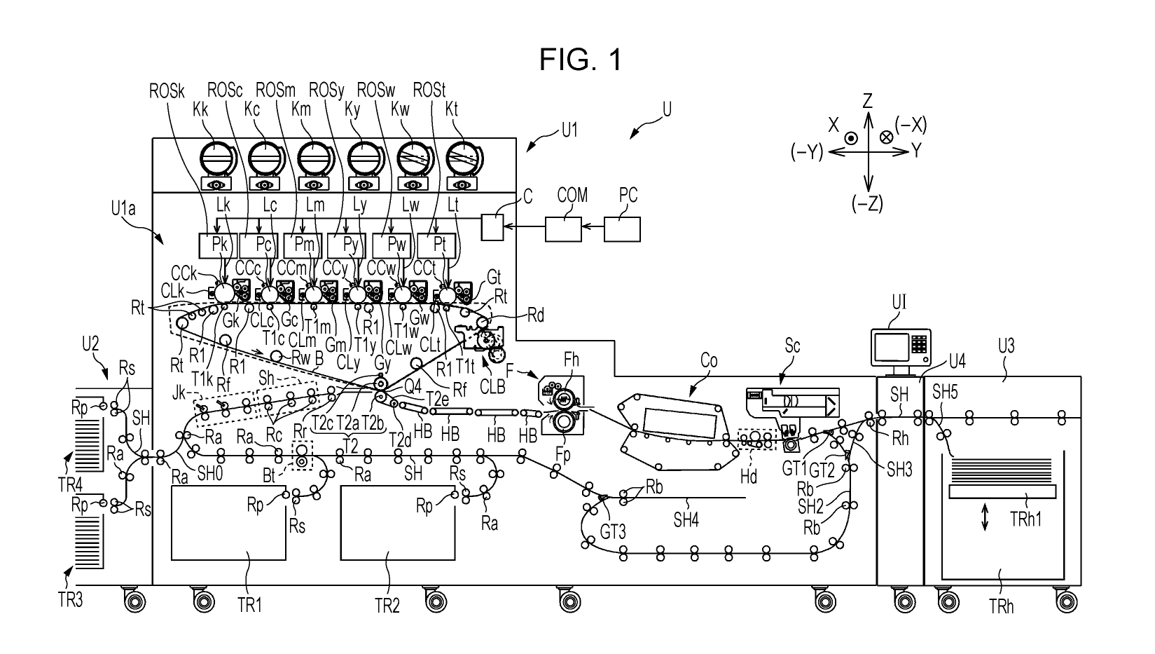

FIG. 1 is an overall view of an image forming apparatus according to a first exemplary embodiment of the present invention.

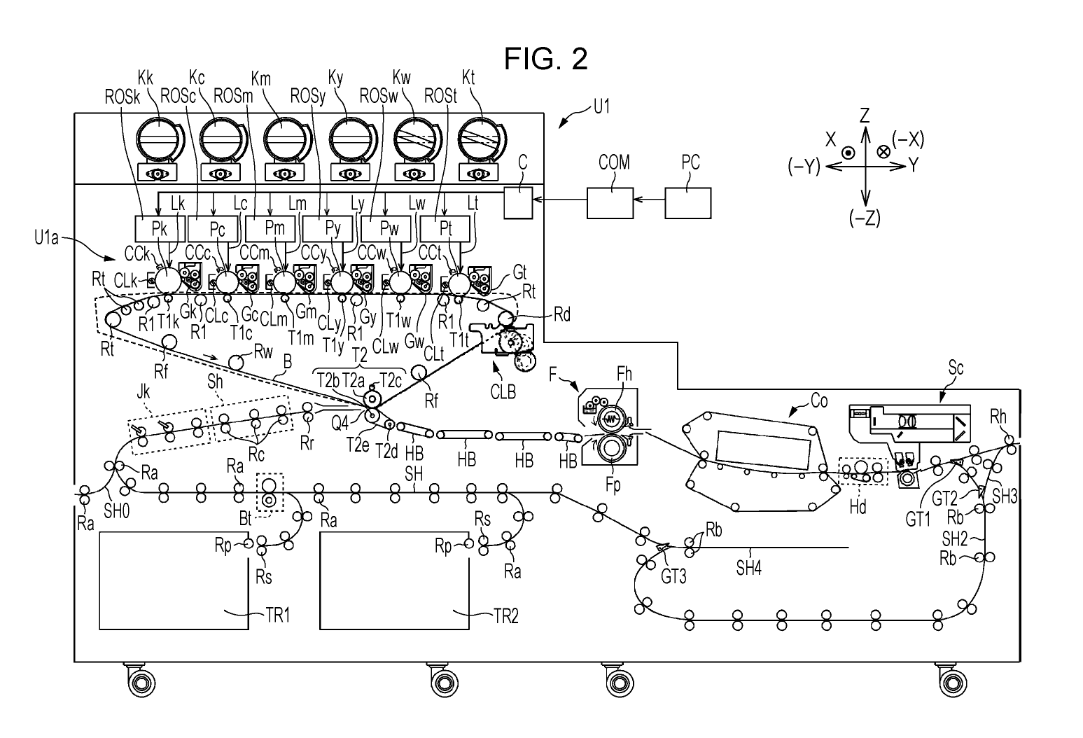

FIG. 2 illustrates a relevant part of the image forming apparatus according to the first exemplary embodiment of the present invention.

Referring to FIGS. 1 and 2, a printer U as an example of the image forming apparatus according to the first exemplary embodiment includes a printer body U1, a feeder unit U2 as an example of a feeding device that feeds a medium to the printer body U1, an output unit U3 as an example of an output device to which a medium having an image recorded thereon is output, an interface module U4 as an example of a connecting unit that connects the printer body U1 and the output unit U3, and an operable unit UI operable by a user.

Configuration of Marking Unit According to First Exemplary Embodiment

Referring to FIGS. 1 and 2, the printer body U1 includes a controller C that controls the printer U, a communicator (not shown) that receives image information transmitted from a print image server COM as an example of an information transmitter externally connected to the printer U via a dedicated cable (not shown), and a marking unit U1a as an example of an image recorder that records an image onto a medium. The print image server COM is connected, via a line such as a cable or a local area network (LAN), to a personal computer PC as an example of an image transmitter that transmits information of an image to be printed in the printer U.

The marking unit U1a includes photoconductors Py, Pm, Pc, and Pk as an example of image bearing members for yellow (Y), magenta (M), cyan (C), and black (K) colors, a white (W) photoconductor Pw, and a transparent-image photoconductor Pt for giving a gloss to an image when printing, for example, a photographic image. The photoconductors Py to Pt have photoconductive dielectric surfaces.

Referring to FIGS. 1 and 2, in the rotational direction of the photoconductor Pk for the black color, a charger CCk, an exposure unit ROSk as an example of a latent-image forming unit, a developing unit Gk, a first-transfer roller T1k as an example of a first-transfer unit, and a photoconductor cleaner CLk as an example of an image-bearing-member cleaner are arranged around the photoconductor Pk. Likewise, chargers CCy, CCm, CCc, CCw, and CCt, exposure units ROSy, ROSm, ROSc, ROSw, and ROSt, developing units Gy, Gm, Gc, Gw, and Gt, first-transfer rollers T1y, T1m, T1c, T1w, and T1t, and photoconductor cleaners CLy, CLm, CLc, CLw, and CLt are respectively arranged around the remaining photoconductors Py, Pm, Pc, Pw, and Pt.

Toner cartridges Ky, Km, Kc, Kk, Kw, and Kt as an example of containers that accommodate therein developers to be supplied to the developing units Gy to Gt are detachably supported above the marking unit U1a.

An intermediate transfer belt B as an example of an intermediate transfer body and an image bearing member is disposed below the photoconductors Py to Pt. The intermediate transfer belt B is interposed between the photoconductors Py to Pt and the first-transfer rollers T1y to T1t. The undersurface of the intermediate transfer belt B is supported by a drive roller Rd as an example of a drive member, a tension roller Rt as an example of a tension applying member, a working roller Rw as an example of a meander prevention member, multiple idler rollers Rf as an example of driven members, a backup roller T2a as an example of a second-transfer opposing member, multiple retracting rollers R1 as an example of movable members, and the aforementioned first-transfer rollers T1y to T1t.

A belt cleaner CLB as an example of an intermediate-transfer-body cleaner is disposed on the top surface of the intermediate transfer belt B near the drive roller Rd.

A second-transfer roller T2b as an example of a second-transfer member is disposed facing the backup roller T2a with the intermediate transfer belt B interposed therebetween. The backup roller T2a is in contact with a contact roller T2c as an example of a contact member for applying a voltage having an opposite polarity relative to the charge polarity of the developers to the backup roller T2a. A transport belt T2e as an example of a transport member is extended between the second-transfer roller T2b according to the first exemplary embodiment and a drive roller T2d as an example of a drive member disposed at the lower right side thereof.

The backup roller T2a, the second-transfer roller T2b, and the contact roller T2c constitute a second-transfer unit T2 as an example of a transfer unit. The first-transfer rollers T1y to T1t, the intermediate transfer belt B, the second-transfer unit T2, and so on constitute a transfer device T1+B+T2 according to the first exemplary embodiment.

Feed trays TR1 and TR2 as an example of containers that accommodate therein recording sheets S as an example of media are provided below the second-transfer unit T2. A pickup roller Rp as an example of a fetching member and a separating roller Rs as an example of a separating member are disposed at the upper right side of each of the feed trays TR1 and TR2. A transport path SH that transports each recording sheet S extends from the separating roller Rs. Multiple transport rollers Ra as an example of transport members that transport each recording sheet S downstream are arranged along the transport path SH.

A deburring device Bt that performs so-called deburring is disposed downstream, in the transport direction of a recording sheet S, of a position where the transport paths SH from the two feed trays TR1 and TR2 merge. The deburring device Bt serves as an example of an unwanted-part removing device that nips a recording sheet S with predetermined pressure and transports the recording sheet S downstream so as to remove an unwanted edge from the recording sheet S.

A multi-feed sensor Jk is disposed downstream of the deburring device Bt. The multi-feed sensor Jk measures the thickness of a passing recording sheet S and detects so-called multi-feeding in which multiple stacked recording sheets S are simultaneously fed. A correcting roller Rc as an example of an orientation corrector that corrects inclination, that is, a so-called skew, relative to the transport direction of the recording sheet S is disposed downstream of the multi-feed sensor Jk. A registration roller Rr as an example of an adjusting member that adjusts the timing for transporting each recording sheet S toward the second-transfer unit T2 is disposed downstream of the correcting roller Rc.

The feeder unit U2 is similarly provided with components, such as feed trays TR3 and TR4 that have configurations similar to those of the feed trays TR1 and TR2, the pickup rollers Rp, the separating rollers Rs, and the transport rollers Ra. A transport path SH from the feed trays TR3 and TR4 merges with the transport path SH in the printer body U1 at the upstream side of the multi-feed sensor Jk.

Multiple transport belts HB as an example of a medium transport device are arranged at the downstream side of the transport belt T2e in the transport direction of the recording sheet S.

A fixing device F is disposed downstream of the transport belts HB in the transport direction of the recording sheet S.

A cooling device Co that cools the recording sheet S is disposed downstream of the fixing device F.

A decurler Hd that applies pressure to the recording sheet S so as to correct bending, that is, so-called curling, of the recording sheet S is disposed downstream of the cooling device Co.

An image reading device Sc that reads the image recorded on the recording sheet S is disposed downstream of the decurler Hd.

An inversion path SH2 as an example of a transport path that diverges from the transport path SH extending toward the interface module U4 is provided downstream of the image reading device Sc. A first gate GT1 as an example of a transport-direction switching member is disposed at the diverging point of the inversion path SH2.

Multiple switchback rollers Rb as an example of transport members that are rotatable in forward and reverse directions are arranged along the inversion path SH2. A connection path SH3 as an example of a transport path that diverges from an upstream section of the inversion path SH2 and merges with the transport path SH at the downstream side of the diverging point of the inversion path SH2 is provided at the upstream side of the switchback rollers Rb. A second gate GT2 as an example of a transport-direction switching member is disposed at the diverging point between the inversion path SH2 and the connection path SH3.

A switchback path SH4 for inverting, that is, switching back, the transport direction of the recording sheet S is disposed downstream of the inversion path SH2 below the cooling device Co. A switchback roller Rb as an example of a transport member that is rotatable in forward and reverse directions is disposed in the switchback path SH4. A third gate GT3 as an example of a transport-direction switching member is disposed at the entrance of the switchback path SH4.

A transport path SH downstream of the switchback path SH4 merges with the transport path SH of the feed trays TR1 and TR2.

The interface module U4 is provided with a transport path SH extending toward the output unit U3.

In the output unit U3, a stacker tray TRh as an example of a stack container on which output recording sheets S are stacked is disposed, and an output path SH5 diverging from the transport path SH extends toward the stacker tray TRh. The transport path SH according to the first exemplary embodiment is configured such that, when an additional output unit (not shown) or an additional post-processing device (not shown) is attached to the right side of the output unit U3, the transport path SH is capable of transporting the recording sheet S to the added unit or device.

Operation of Marking Unit

When the printer U receives image information transmitted from the personal computer PC via the print image server COM, the printer U commences a job, which is an image forming operation. When the job commences, the photoconductors Py to Pt, the intermediate transfer belt B, and so on rotate.

The photoconductors Py to Pt are rotationally driven by a drive source (not shown).

The chargers CCy to CCt receive a predetermined voltage so as to electrostatically charge the surfaces of the photoconductors Py to Pt.

The exposure units ROSy to ROSt output laser beams Ly, Lm, Lc, Lk, Lw, and Lt as an example of latent-image write-in light in accordance with a control signal from the controller C so as to write electrostatic latent images onto the electrostatically-charged surfaces of the photoconductors Py to Pt.

The developing units Gy to Gt develop the electrostatic latent images on the surfaces of the photoconductors Py to Pt into visible images.

The toner cartridges Ky to Kt supply developers as the developers are consumed in the developing process performed in the developing units Gy to Gt.

The first-transfer rollers T1y to T1t receive a first-transfer voltage with an opposite polarity relative to the charge polarity of the developers so as to transfer the visible images on the surfaces of the photoconductors Py to Pt onto the surface of the intermediate transfer belt B.

The photoconductor cleaners CLy to CLt clean the surfaces of the photoconductors Py to Pt after the first-transfer process by removing residual developers therefrom.

When the intermediate transfer belt B passes through first-transfer regions where the intermediate transfer belt B faces the photoconductors Py to Pt, T, W, Y, M, C, and K images are transferred and superposed on the intermediate transfer belt B in that order, and the intermediate transfer belt B subsequently travels through a second-transfer region Q4 where the intermediate transfer belt B faces the second-transfer unit T2. In a case where a monochrome image is to be formed, an image of a single color is transferred onto the intermediate transfer belt B and is transported to the second-transfer region Q4.

In accordance with the size of the received image information, the designated type of recording sheets S, and the sizes and types of accommodated recording sheets S, one of the pickup rollers Rp feeds recording sheets S from the corresponding one of the feed trays TR1 to TR4 from which the recording sheets S are to be fed.

The corresponding separating roller Rs separates the recording sheets S fed by the pickup roller Rp in a one-by-one fashion.

The deburring device Bt applies predetermined pressure onto each passing recording sheet S so as to remove a burr therefrom.

The multi-feed sensor Jk detects the thickness of each passing recording sheet S so as to detect multi-feeding of recording sheets S.

The correcting roller Rc brings each passing recording sheet S into contact with a wall (not shown) so as to correct a skew thereof.

The registration roller Rr feeds each recording sheet S in accordance with a timing at which the image on the surface of the intermediate transfer belt B is transported to the second-transfer region Q4.

In the second-transfer unit T2, a predetermined second-transfer voltage having the same polarity as the charge polarity of the developers is applied to the backup roller T2a via the contact roller T2c so that the image on the intermediate transfer belt B is transferred onto the recording sheet S.

The belt cleaner CLB cleans the surface of the intermediate transfer belt B after the image transfer process performed at the second-transfer region Q4 by removing residual developers therefrom.

The recording sheet S having the image transferred thereon at the second-transfer unit T2 is transported downstream by the transport belts T2e and HB while being supported on the surfaces thereof.

The fixing device F includes a heating roller Fh as an example of a heating member and a pressing roller Fp as an example of a pressing member. The heating roller Fh accommodates therein a heater as an example of a heat source. The fixing device F heats and presses the recording sheet S passing through a region where the heating roller Fh and the pressing roller Fp are in contact with each other so as to fix an unfixed image onto the surface of the recording sheet S.

The cooling device Co cools the recording sheet S heated by the fixing device F.

The decurler Hd applies pressure onto the recording sheet S that has passed through the cooling device Co so as to remove bending, that is, so-called curling, of the recording sheet S.

The image reading device Sc reads the image from the surface of the recording sheet S that has passed through the decurler Hd.

In the case of duplex printing, the recording sheet S that has passed through the decurler Hd is transported to the inversion path SH2 as a result of activation of the first gate GT1 and is switched back in the switchback path SH4 so as to be transported again to the registration roller Rr via the transport path SH, whereby printing is performed on the second face of the recording sheet S.

The recording sheet S to be output to the stacker tray TRh is transported along the transport path SH so as to be output onto the stacker tray TRh. In this case, if the recording sheet S to be output to the stacker tray TRh is in an inverted state, the recording sheet S is temporarily transported to the inversion path SH2 from the transport path SH. After the trailing edge of the recording sheet S in the transport direction thereof passes through the second gate GT2, the second gate GT2 is switched and the switchback rollers Rb are rotated in the reverse direction so that the recording sheet S is transported along the connection path SH3 toward the stacker tray TRh.

When multiple recording sheets S are stacked on the stacker tray TRh, a stacker plate TRh1 automatically moves upward or downward in accordance with the number of stacked recording sheets S so that the uppermost sheet is disposed at a predetermined height.

Controller According to First Exemplary Embodiment

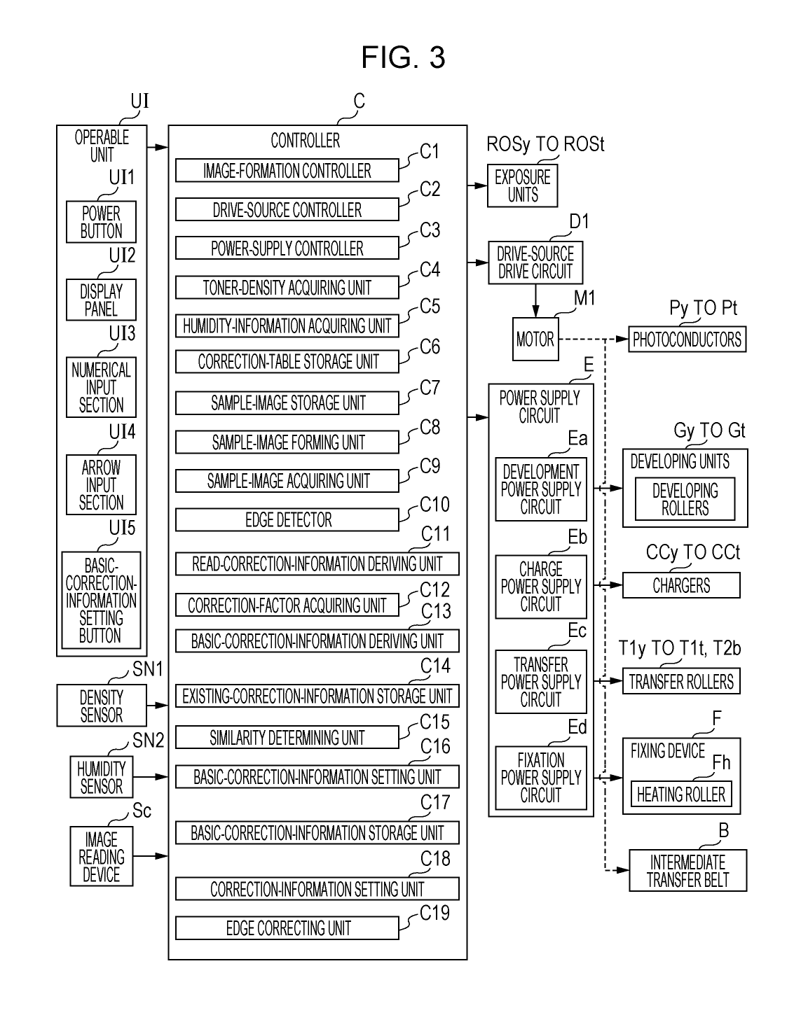

FIG. 3 is a block diagram illustrating functions included in the controller C of the image forming apparatus according to the first exemplary embodiment.

Referring to FIG. 3, the controller C of the printer body U1 includes an input/output interface I/O that exchanges signals with the outside. The controller C also includes a read-only memory (ROM) that stores, for example, information as well as programs for executing processing. Moreover, the controller C includes a random access memory (RAM) that temporarily stores data. Furthermore, the controller C includes a central processing unit (CPU) that performs processing in accordance with a program stored in, for example, the ROM. Therefore, the controller C according to the first exemplary embodiment is constituted of a small-size information processor, namely, a so-called microcomputer. Thus, the controller C is capable of achieving various functions by executing the programs stored in, for example, the ROM.

Signal Output Components Connected to Controller C of Printer Body U1

The controller C of the printer body U1 receives output signals from signal output components, such as the operable unit UI, the image reading device Sc, a density sensor SN1, and a humidity sensor SN2.

The operable unit UI includes a power button UI1 as an example of a power switch, a display panel UI2 as an example of a display, a numerical input section U13 as an example of an input section, an arrow input section UI4, and a basic-correction-information setting button UI5.

The image reading device Sc as an example of a reading member reads an image passing through the position of the image reading device Sc.

The density sensor SN1 as an example of a density detecting member detects the toner density of the developer accommodated within each of the developing units Gy to Gt.

The humidity sensor SN2 as an example of a humidity detecting member detects the ambient humidity of the printer U.

Controlled Components Connected to Controller C of Printer Body U1

The controller C of the printer body U1 is connected to a drive-source drive circuit D1, a power supply circuit E, and other controlled components (not shown). The controller C outputs control signals to, for example, the circuits D1 and E.

The drive-source drive circuit D1 rotationally drives, for example, the photoconductors Py to Pt and the intermediate transfer belt B via a motor M1 as an example of a drive source.

The power supply circuit E includes a development power supply circuit Ea, a charge power supply circuit Eb, a transfer power supply circuit Ec, and a fixation power supply circuit Ed.

The development power supply circuit Ea applies development voltage to developing rollers of the developing units Gy to Gt.

The charge power supply circuit Eb applies charge voltage to the chargers CCy to CCt so as to electrostatically charge the surfaces of the photoconductors Py to Pt.

The transfer power supply circuit Ec applies transfer voltage to the first-transfer rollers T1y to T1t and the second-transfer roller T2b.

The fixation power supply circuit Ed supplies electric power for heating the heating roller Fh of the fixing device F.

Function of Controller C of Printer Body U1

The controller C of the printer body U1 has a function of executing processing according to input signals from the signal output components and outputting control signals to the controlled components. Specifically, the controller C has the following functions.

An image-formation controller C1 controls, for example, the driving of each component in the printer U and the voltage application timing in accordance with image information input from the personal computer PC so as to execute a job, which is an image forming operation.

A drive-source controller C2 controls the driving of the motor M1 via the drive-source drive circuit D1 so as to control the driving of, for example, the photoconductors Py to Pt.

A power-supply controller C3 controls the power supply circuits Ea to Ed so as to control the voltage to be applied to each component and the electric power to be supplied to each component. Specifically, the power-supply controller C3 according to the first exemplary embodiment also controls the transfer power supply circuit Ec so as to control the transfer voltage to be applied to the second-transfer roller T2b via the contact roller T2c.

A toner-density acquiring unit C4 acquires a toner density as an example of a development condition based on a detection result of the density sensor SN1.

A humidity-information acquiring unit C5 acquires ambient humidity as an example of a development condition based on a detection result of the humidity sensor SN2.

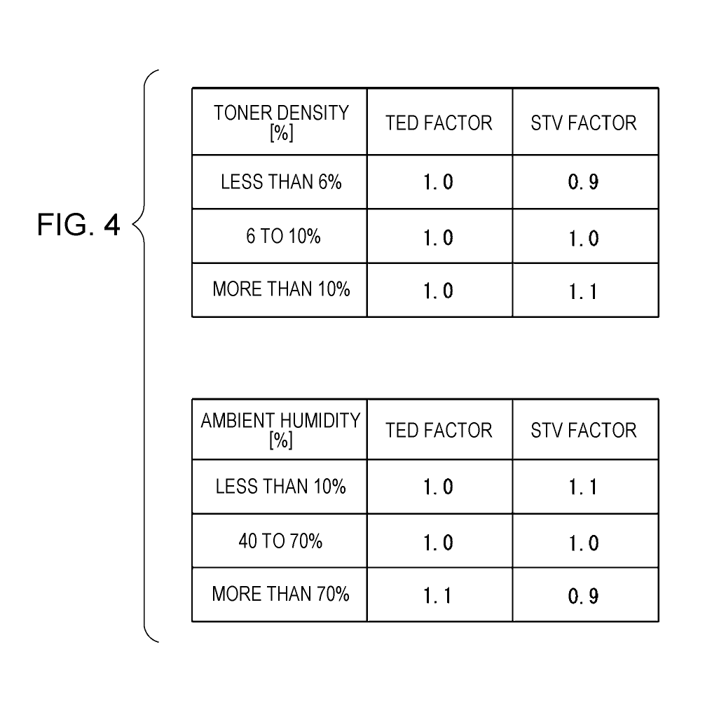

FIG. 4 illustrates a table of correction factors used for correcting a density correction value based on development conditions in accordance with the first exemplary embodiment.

A correction-table storage unit C6 as an example of a condition-correction-information memory stores a correction table as an example of condition correction information for correcting a density correction value as an example of correction information based on development conditions. In FIG. 4, the correction table according to the first exemplary embodiment is stored in association with each of the toner density and ambient humidity as examples of development conditions. In the correction table according to the first exemplary embodiment, a trail edge deletion (TED) factor as an example of TED condition correction information and a starvation (STV) factor as an example of STV condition correction information are stored in correspondence with TED and STV, respectively. In the first exemplary embodiment, the TED factor and the STV factor are derived and set in association with each of the toner density and ambient humidity by performing tests in advance.

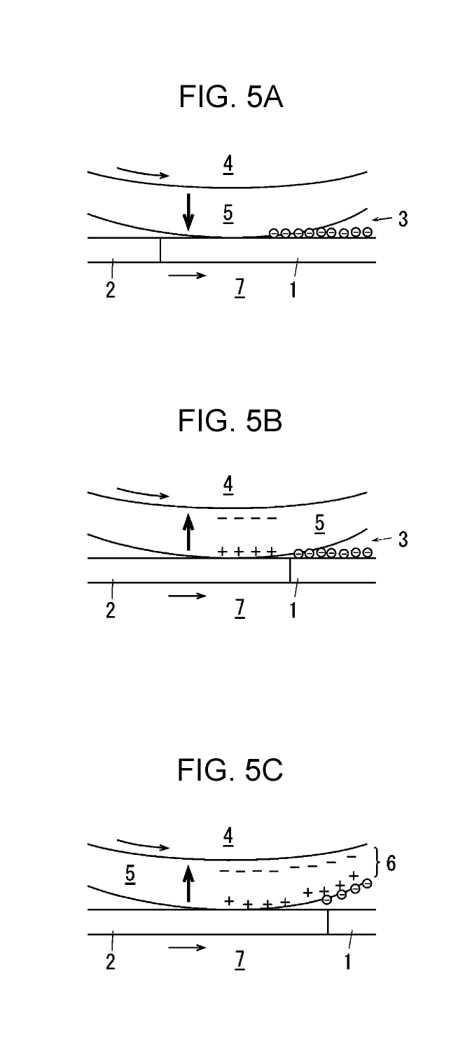

FIGS. 5A to 5C illustrate a mechanism of how TED occurs. Specifically, FIG. 5A illustrates a state where an image portion is passing through a developing region, FIG. 5B illustrates a state where a blank portion (i.e., a background image portion) is passing through the developing region, and FIG. 5C illustrates a state where TED has occurred.

In FIGS. 5A to 5C, TED tends to occur in a boundary area, that is, a so-called edge area, when, for example, a blank portion (i.e., a background image portion) 2 passes through a developing region 3 subsequent to an image portion 1, such as a halftone image, that is, when a low-density image passes through the developing region subsequent to a high-density image. Referring to FIG. 5A, when the image portion 1 passes through the developing region 3, a developer 5 held on the surface of a developing roller 4 as an example of a developer bearing member transfers to the image portion 1, so that a latent image is developed into a visible image.

Referring to FIG. 5B, when the subsequent blank portion 2 reaches the developing region 3, the developer 5 does not transfer to the blank portion 2 but receives development voltage, so that polarization 6 occurs within the developer 5.

Referring to FIG. 5C, in a case where the developing roller 4 rotates faster than a photoconductor 7, the developer with the polarization 6 moves past the blank portion 2 so as to reach a region of the image portion 1 that has already undergone a development process. In this case, if the polarization 6 is not canceled, the developer transferred to the image portion 1 is drawn toward the electric charge in the polarization 6 so as to transfer toward the developing roller 4. Thus, a so-called TED phenomenon occurs in which the density of the image to be printed decreases in the boundary area between the image portion 1 and the blank portion 2.

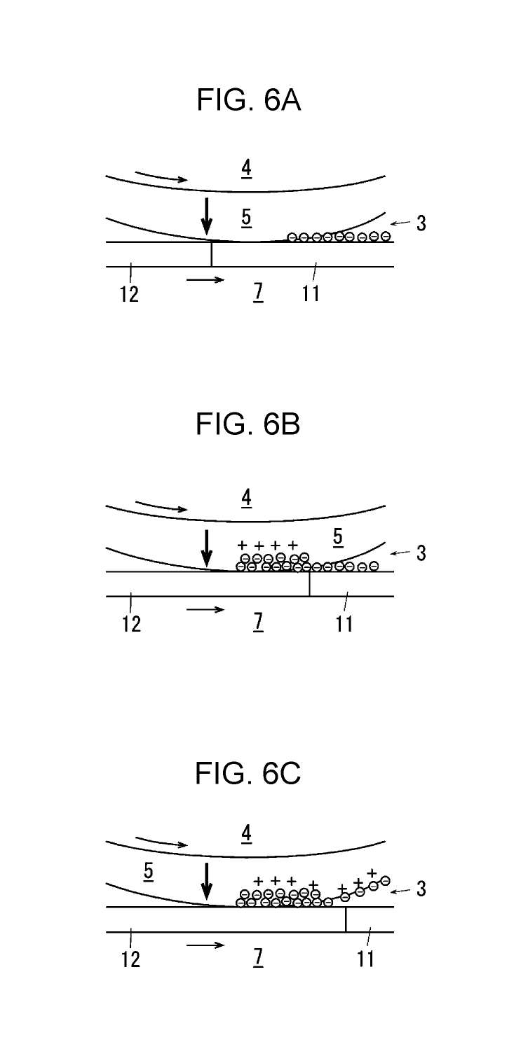

FIGS. 6A to 6C illustrate a mechanism of how STV occurs. Specifically, FIG. 6A illustrates a state where a halftone image portion is passing through the developing region, FIG. 6B illustrates a state where a solid image portion is passing through the developing region, and FIG. 6C illustrates a state where STV has occurred.

In FIGS. 6A to 6C, STV tends to occur in an edge area when, for example, a solid image portion 12 passes through the developing region 3 subsequent to an image portion 11, such as a halftone image, that is, when a high-density image passes through the developing region subsequent to a low-density image. Referring to FIG. 6A, when the image portion 11 passes through the developing region 3, the developer 5 held on the surface of the developing roller 4 transfers to the image portion 11, so that a latent image is developed into a visible image.

Referring to FIG. 6B, when the subsequent solid image portion 12 reaches the developing region 3, a large amount of toner transfers to the solid image portion 12. In a case where the toner has negative charge polarity, if a large amount of negative polarity toner transfers to the photoconductor 7, the developer 5 remaining on the developing roller 4 would have positive charge polarity in its entirety.

Referring to FIG. 6C, in a case where the developing roller 4 rotates faster than the photoconductor 7, the developer 5 with the positive charge polarity moves past the solid image portion 12 so as to reach a region of the image portion 11 that has already undergone a development process. In this case, the toner in the image portion 11 is drawn toward the entirely positively-charged developer 5 so as to transfer toward the developing roller 4. Thus, a so-called STV phenomenon occurs in which the density of the image to be printed decreases in the boundary area between the image portion 11 and the solid image portion 12.

Accordingly, both of TED and STV are image defects occurring in image boundary areas and edges, and are sometimes referred to as edge defects.

Although TED is hardly affected by changes in toner density, the present inventors have discovered from tests that TED is affected by a change in fluidity of the developer occurring due to a change in humidity. Moreover, it has been discovered that STV is also affected by the toner density and humidity. Therefore, in the correction-table storage unit C6 according to the first exemplary embodiment, the TED factor and the STV factor are each stored in association with the development conditions including the toner density and humidity.

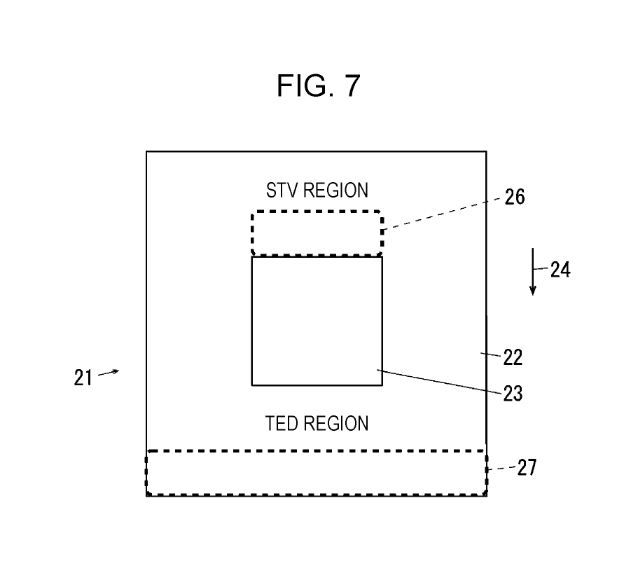

FIG. 7 illustrates an image to be used when deriving basic correction information according to the first exemplary embodiment.

A sample-image storage unit C7 as an example of a basic-correction-information-deriving-image storage unit stores a sample image 21 as an example of an image for deriving basic correction information. Referring to FIG. 7, for example, the sample image 21 according to the first exemplary embodiment has a solid image portion 23 with a density of 100% in the middle of a halftone image portion 22 having multiple Cin or a halftone with a density of 30% to 70% as an example of a predetermined density. Therefore, STV tends to occur in a leading region 26 of the solid image portion 23 in a direction 24 in which the sample image 21 is formed, and TED tends to occur in a trailing edge region 27 of the halftone image portion 22.

In a case where an input is received via the basic-correction-information setting button UI5, a sample-image forming unit C8 prints the sample image 21 as an example of an image for generating predetermined correction information via the image-formation controller C1.

A sample-image acquiring unit C9 acquires a read result obtained by the image reading device Sc reading the sample image 21.

An edge detector C10 as an example of a boundary detector detects the boundaries of the image portions 1, 2, 11, 12, 22, and 23. The edge detector C10 according to the first exemplary embodiment detects the boundaries of the image portions 22 and 23 in the sample image 21 read by the image reading device Sc. In the first exemplary embodiment, for example, the boundaries of the image portions 22 and 23 are detected when the density values (pixel values) of neighboring pixels in the read image information are larger than or equal to a predetermined threshold value. The edge-boundary detection method is known in the related art and will not be described in detail since the techniques described in, for example, Japanese Patent Nos. 3832519 and 3832521 may be used.

A read-correction-information deriving unit C11 as an example of a first deriving unit derives read correction information based on the read result of the sample image 21. The read-correction-information deriving unit C11 according to the first exemplary embodiment determines the leading region 26 and the trailing edge region 27 from the edge of the read sample image 21 and derives read correction information for STV from the leading region 26 and read correction information for TED from the trailing edge region 27. In the first exemplary embodiment, for example, in a case where it is determined that the density of a pixel distant from the edge of the trailing edge region 27, that is, the edge of the halftone image portion 22, by x pixels is b[%], a density difference y=(c−b) [%] between a density c[%] of the halftone image portion 22 and the density b is derived as read correction information, that is, a density correction value, for TED. Likewise, for STV, a pixel position x′ and a density correction value y′ are derived as read correction position for STV.

A correction-factor acquiring unit C12 as an example of a condition-correction-information acquiring unit acquires condition correction information in accordance with the development conditions. The correction-factor acquiring unit C12 according to the first exemplary embodiment acquires a TED factor α0 and an STV factor β0 from the correction tables shown in FIG. 4 in accordance with the toner density and the humidity.

A basic-correction-information deriving unit C13 as an example of a second deriving unit derives basic correction information based on the read correction information derived by the read-correction-information deriving unit C11 and the development conditions when the sample image 21 is formed. In the basic-correction-information deriving unit C13 according to the first exemplary embodiment, basic correction information is derived from the read correction information (x, y) and the read correction information (x′, y′) derived from the sample image 21 and the TED factor α0 and the STV factor β0 corresponding to the toner density and the humidity when the sample image 21 is printed. For example, if the toner density is 11% and the humidity is 35%, the TED factor α0 is 1.0. The STV factor β0 is 1.1× based on the toner density, that is, 0.1× (10%) higher than 1×, and is 1.1× based on the humidity. Therefore, in the first exemplary embodiment, the STV factor β0 is 1.2 (=1×+0.1×+0.1×). Then, y/α0=(c−b) is derived as TED basic correction information as an example of first basic correction information. Likewise, y′/β0=(c−b′)/1.2 is derived as STV basic correction information as an example of second basic correction information. Accordingly, in the first exemplary embodiment, the basic correction information corresponds to information for density correction in TED or STV when there is no effect of the development conditions.

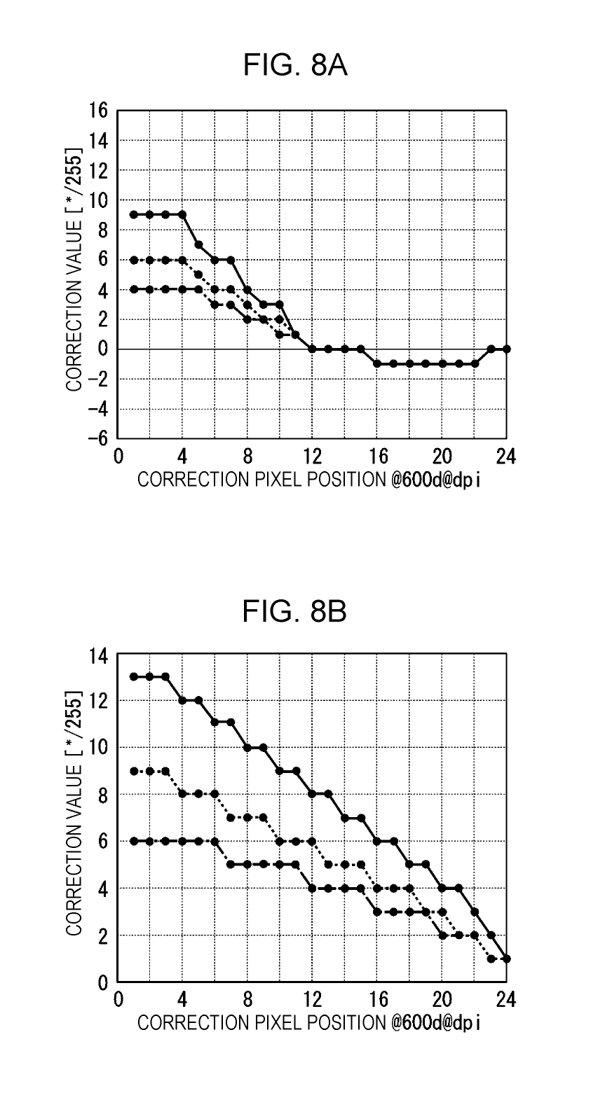

FIGS. 8A and 8B illustrate existing basic correction information according to the first exemplary embodiment. Specifically, FIG. 8A is a graph showing basic correction information for TED, and FIG. 8B is a graph showing basic correction information for STV.

In the graph shown in each of FIGS. 8A and 8B, the abscissa axis indicates a pixel position, and the ordinate axis indicates a density correction value.

An existing-correction-information storage unit C14 stores existing correction information (X, Y) and existing correction information (X′, Y′) as an example of basic correction information set in advance based on, for example, tests. Referring to FIGS. 8A and 8B, in the first exemplary embodiment, basic correction information is derived multiple times in advance based on, for example, tests with respect to the model of the printer U, and the existing correction information (X, Y) and the existing correction information (X′, Y′) are derived from an average value of the basic correction information and are stored. In the first exemplary embodiment, three kinds of existing correction information (X, Y) and existing correction information (X′, Y′) are derived and stored in advance in correspondence with when the density correction is large, when the correction is at about an intermediate level, and when the correction is small.

A similarity determining unit C15 determines whether or not the existing correction information (X, Y) and the existing correction information (X′, Y′) are similar to the basic correction information (x, y/α0) and the basic correction information (x′, y′/β0) derived by the basic-correction-information deriving unit C13. For example, in the case of TED, the similarity determining unit C15 according to the first exemplary embodiment calculates a correlation coefficient of a density value of the existing correction information at each of the positions x and X and density values y/α0 and Y of the basic correction information. If the value of the correlation coefficient is larger than a predetermined threshold value (e.g., 0.8), the similarity determining unit C15 may determine that the existing correction information (X, Y) and the existing correction information (X′, Y′) are similar to the basic correction information (x, y/α0) and the basic correction information (x′, y′/β0). The determination of whether or not the existing correction information and the basic correction information are similar to each other is not limited to the case where a correlation coefficient is used. For example, the similarity determination may be performed based on a freely-chosen determination method, such as performing a frequency analysis with respect to a curve on a graph. In the case where a correlation coefficient is used, the determination may be performed by deriving the correlation coefficient by discretely extracting values, as in a case where the positions x and X are 5, 10, 15, 20, and so on, instead of performing the determination on all of the values, so that the processing load may be reduced.

A basic-correction-information setting unit C16 sets the basic correction information to be used in the printer U. In a case where the similarity determining unit C15 determines that the derived basic correction information (x, y/α0) and the derived basic correction information (x′, y′/β0) are similar to either the existing correction information (X, Y) or (X′, Y′), the basic-correction-information setting unit C16 according to the first exemplary embodiment sets the existing correction information (X, Y) or (X′, Y′) determined to be similar to the derived basic correction information as basic correction information (X, Y) and basic correction information (X′, Y′). In contrast, if it is determined that the derived basic correction information (x, y/α0) and the derived basic correction information (x′, y′/β0) are not similar to either the existing correction information (X, Y) or (X′, Y′), the derived basic correction information (x, y/α0) and the derived basic correction information (x′, y′/β0) are set as the basic correction information to be used in the printer U.

A basic-correction-information storage unit C17 stores the basic correction information set by the basic-correction-information setting unit C16.

A correction-information setting unit C18 as an example of a third deriving unit derives and sets correction information to be used in image formation based on the development conditions. The correction-information setting unit C18 according to the first exemplary embodiment first acquires the toner density and the humidity at the time of image formation and acquires a TED factor al and an STV factor β1 in accordance with the toner density and the humidity. Then, correction information (x, y·(α1/α0)), (x′, y′·(β1/β0)), (X, Y·α1), and (X′, Y′·β1) to be used in image formation are derived from the acquired correction factors α1 and β1 and the basic correction information (x, y/α), (x′, y′/β0), (X, Y), and (X′, Y′) stored in the basic-correction-information storage unit C17. Specifically, the TED correction information (x, y·(α1/α0)) (or (X, Y·α1)) as an example of first correction information and the STV correction information (x′, y′·(β1/β0)) (or (X′, Y′·β1)) as an example of second correction information are derived.

An edge correcting unit C19 as an example of an image correcting unit corrects an image during an image forming operation by using the correction information set by the correction-information setting unit C18. The edge correcting unit C19 according to the first exemplary embodiment detects an edge from received image data in a manner similar to the edge detector C10. Then, if the leading region 26 or the trailing edge region 27 where TED or STV may possibly occur is present in the image to be printed, the density of pixels in the leading region 26 or the trailing edge region 27 is corrected by using the correction information. Since the method of correcting an image corresponding to TED by using the correction information is known in the related art and is described in, for example, Japanese Patent Nos. 3832519 and 3832521, a detailed description will be omitted. Because STV involves a similar process except that the correction information to be used differs from that in the case of TED, a detailed description will be omitted.

Flowchart According to First Exemplary Embodiment

Next, a flowchart illustrating the flow of control performed in the printer U according to the first exemplary embodiment will be described.

Flowchart of Basic-Correction-Information Setting Process

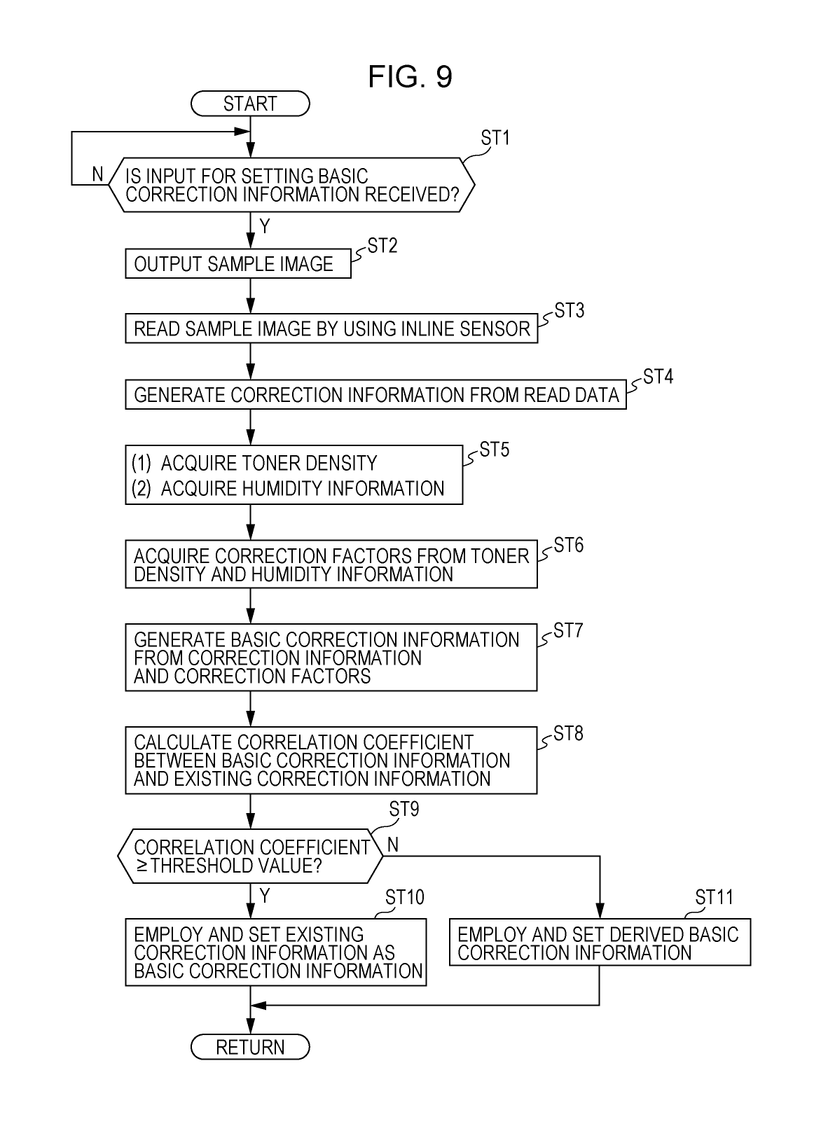

FIG. 9 illustrates a flowchart of a basic-correction-information setting process according to the first exemplary embodiment.

The process of steps ST in the flowchart in FIG. 9 is performed in accordance with a program stored in the controller C of the printer U. This process is executed concurrently with other various processes in the printer U.

The flowchart in FIG. 9 commences when the power of the printer U is turned on.

In step ST1 in FIG. 9, it is determined whether or not an input is received from the operable unit UI via the basic-correction-information setting button UI5. If yes (Y), the process proceeds to step ST2. If not (N), step ST1 is repeated.

In step ST2, the sample image 21 is output. Then, the process proceeds to step ST3.

In step ST3, the sample image 21 is read by the image reading device Sc. Then, the process proceeds to step ST4.

In step ST4, read correction information (x, y) and read correction information (x′, y′) are generated from read data. The process then proceeds to step ST5.

In step ST5, the following processes (1) and (2) are executed, and the process then proceeds to step ST6.

(1) Toner density is acquired.

(2) Humidity information is acquired.

In step ST6, correction factors α0 and β0 are acquired from the toner density and the humidity information. Then, the process proceeds to step ST7.

In step ST7, basic correction information (x, y/α0) and basic correction information (x′, y′/β0) are derived from the correction information and the correction factors α0 and β0. Then, the process proceeds to step ST8.

In step ST8, a correlation coefficient between the basic correction information (x, y/α0) and (x′, y′/β0) and the existing correction information (X, Y) and (X′, Y′) is calculated. Then, the process proceeds to step ST9.

In step ST9, it is determined whether or not the correlation coefficient is larger than or equal to a threshold value. If yes (Y), the process proceeds to step ST10. If not (N), the process proceeds to step ST11.

In step ST10, the existing correction information is employed and set as the basic correction information. Then, the process returns to step ST1.

In step ST11, the basic correction information derived from the read correction information is employed and set as the basic correction information. Then, the process returns to step ST1.

Flowchart of Correction-Information Setting Process

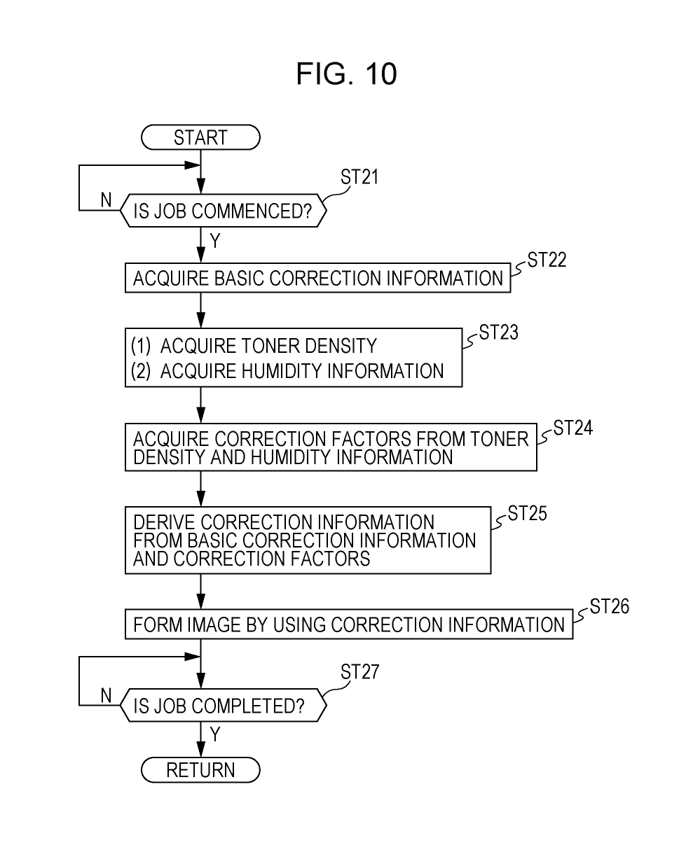

FIG. 10 illustrates a flowchart of a correction-information setting process according to the first exemplary embodiment.

The process of steps ST in the flowchart in FIG. 10 is performed in accordance with a program stored in the controller C of the printer U. This process is executed concurrently with other various processes in the printer U.

The flowchart in FIG. 10 commences when the power of the printer U is turned on.

In step ST21 in FIG. 10, it is determined whether or not a job as an example of an image forming operation is commenced, that is, whether or not image information is received in the first exemplary embodiment. If yes (Y), the process proceeds to step ST22. If not (N), step ST21 is repeated.

In step ST22, basic correction information is acquired. Then, the process proceeds to step ST23.

In step ST23, the following processes (1) and (2) are executed, and the process proceeds to step ST24.

(1) Toner density is acquired.

(2) Humidity information is acquired.

In step ST24, correction factors α1 and β1 are acquired from the toner density and the humidity information. Then, the process proceeds to step ST25.

In step ST25, correction information is derived from the basic correction information and the correction factors α1 and β1. Then, the process proceeds to step ST26.

In step ST26, image formation is performed by using the correction information. Accordingly, if the leading region 26 or the trailing edge region 27 where TED or STV may possibly occur is present in the image, image correction is performed. The process then proceeds to step ST27.

In step ST27, it is determined whether or not the job is completed. If not (N), step ST27 is repeated. If yes (Y), the process returns to step ST21.

Function of Image Forming Process According to First Exemplary Embodiment

When the printer U according to the first exemplary embodiment having the above-described configuration receives image information and commences a job, the printer U derives basic correction information and correction information based on the development conditions. Then, when an edge is detected and the leading region 26 or the trailing edge region 27 is present in the received image information, the image is corrected by using the correction information.

In the related art described in Japanese Patent Nos. 3832519 and 3832521, the correction information is set in advance, and image correction is performed by using the same correction information even if there is a change in the development conditions, that is, even if the toner density or the humidity changes. Therefore, in the actual condition in which the image formation is performed, the correction is sometimes excessive or insufficient. Thus, the image quality is sometimes not sufficiently improved by the correction.

In contrast, when image formation is to be performed in the first exemplary embodiment, correction information is set in accordance with the development conditions. Therefore, excessive correction or insufficient correction occurring in the techniques described in Japanese Patent Nos. 3832519 and 3832521 may be reduced. Accordingly, in the first exemplary embodiment, the image quality may be improved, as compared with the related art described in Japanese Patent Nos. 3832519 and 3832521.

Furthermore, in the first exemplary embodiment, the correction information is set based on basic correction information from which the effects of the development conditions are excluded. Then, the basic correction information is derived by outputting the sample image 21. Therefore, the correction information based on the basic correction information is set in view of individual differences among printers U. Thus, the basic correction information is derived in view of the individual differences among the developing units Gy to Gt, the individual differences of eccentricity among the photoconductors and the developing rollers, and the individual differences of intervals of the developing regions (i.e., intervals of the photoconductors Py to Pt and the developing rollers). Consequently, appropriate correction may be performed, as compared with the configurations described in Japanese Patent Nos. 3832519 and 3832521 in which correction information set in advance for the model of the image forming apparatus is used. Thus, the image quality may be improved.

Furthermore, when setting the basic correction information in the first exemplary embodiment, existing correction information is used if the basic correction information derived from the sample image 21 is similar to the existing correction information. The existing correction information is derived from an average of a sufficient number of pieces of basic correction information, and has average density correction, has reduced errors, and has a low possibility of containing noise, detection errors, and so on. Therefore, the image quality may be improved, as compared with a case where the similarity determination is not performed.

Furthermore, in the first exemplary embodiment, different pieces of correction information are used between TED and STV. Thus, appropriate correction may be performed in accordance with the location and the cause of an image defect, as compared with a case where the same correction information is used for TED and STV. Consequently, the image quality may be improved.

### Modifications

Although the exemplary embodiment of the present invention has been described in detail above, the present invention is not to be limited to the above exemplary embodiment and permits various modifications within the technical scope of the invention defined in the claims. Modifications H01 to H08 will be described below.

In a first modification H01, the image forming apparatus according to the above exemplary embodiment is not limited to the printer U, and may be, for example, a copier, a facsimile apparatus, or a multifunction apparatus having multiple functions or all functions of such apparatuses.

In the above exemplary embodiment, an image forming apparatus that uses six kinds of developers is described. Alternatively, for example, in a second modification H02, the exemplary embodiment may be applied to a monochrome image forming apparatus or to an image forming apparatus that uses developers for five or fewer colors or seven or more colors. Furthermore, the exemplary embodiment is not limited to the configuration that uses the intermediate transfer belt B and may be applied to an image forming apparatus that directly transfers images from the photoconductors Py to Pt onto a sheet. Moreover, the exemplary embodiment is not limited to a tandem-type image forming apparatus and may alternatively be applied to a rotary-type image forming apparatus.

In the above exemplary embodiment, the toner density, the humidity, and the individual differences of the components constituting the printer U are described as examples of development conditions. Alternatively, in a third modification H03, for example, the correction information may be derived and set in view of the rotational speeds of the photoconductors Py to Pt and the developing rollers, the degree of deterioration of the developers (such as the amount of charge in the developers and the cumulative drive time of the developing units in a state where they are not resupplied with developers), and the development bias.

In the above exemplary embodiment, the sample image 21 is read by the image reading device Sc disposed in the transport path SH. Alternatively, in a fourth modification H04, for example, in a configuration having a printer unit and a scanner unit as an example of a reading member, as in a copier, a sheet having the sample image 21 printed thereon may be output onto an output tray, and the sheet set on the scanner unit by the operator may be read.

In the above exemplary embodiment, the specific configuration of the sample image 21 and the specific configuration in which three kinds of existing correction information are prepared are not limited to those exemplified. In a fifth modification H05, the specific configurations may be changed, where appropriate, in accordance with the design and specifications.

In the above exemplary embodiment, the similarity determination with respect to the existing correction information and the basic correction information is performed, and if the existing correction information and the basic correction information are similar to each other, the existing correction information is used. Alternatively, in a sixth modification H06, the basic correction information based on the read correction information may be used instead of using the existing correction information.

In the above exemplary embodiment, it is desirable that the basic correction information be derived based on the sample image 21. Alternatively, in a seventh modification H07, the existing correction information may be used to derive correction information for each job based on development conditions.

In the above exemplary embodiment, it is desirable to use the TED correction information and the STV correction information. Alternatively, in an eighth modification H08, the same correction information may be used.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming method comprising:
performing image correction on a region where an image is to be corrected by using correction information set based on a development condition, the region where the image is to be corrected being determined based on a density difference in the image to be formed.

2. The image forming method according to claim 1, further comprising:
deriving read correction information based on a read result of a predetermined image for generating correction information;
deriving basic correction information based on the read correction information and the development condition in a case where the image is formed; and
deriving the correction information based on the basic correction information and the development condition during image formation in a case where the image formation is to be performed.

3. The image forming method according to claim 2, further comprising:
deriving the correction information based on preliminarily-stored basic correction information in a case where the preliminarily-stored basic correction information is similar to the basic correction information derived based on the read correction information.

4. The image forming method according to claim 1,
wherein the development condition includes a developer density and humidity.

5. The image forming method according to claim 2,
wherein the development condition includes a developer density and humidity.

6. The image forming method according to claim 3,
wherein the development condition includes a developer density and humidity.

7. The image forming method according to claim 1,
wherein the correction information includes first correction information corresponding to a case where a low-density image region follows a high-density image region in a rotational direction of the image bearing member and second correction information corresponding to a case where a high-density image region follows a low-density image region in the rotational direction of the image bearing member.

8. The image forming method according to claim 2,
wherein the correction information includes first correction information corresponding to a case where a low-density image region follows a high-density image region in a rotational direction of the image bearing member and second correction information corresponding to a case where a high-density image region follows a low-density image region in the rotational direction of the image bearing member.

9. The image forming method according to claim 3,
wherein the correction information includes first correction information corresponding to a case where a low-density image region follows a high-density image region in a rotational direction of the image bearing member and second correction information corresponding to a case where a high-density image region follows a low-density image region in the rotational direction of the image bearing member.

10. The image forming method according to claim 4,
wherein the correction information includes first correction information corresponding to a case where a low-density image region follows a high-density image region in a rotational direction of the image bearing member and second correction information corresponding to a case where a high-density image region follows a low-density image region in the rotational direction of the image bearing member.

11. The image forming method according to claim 5,
wherein the correction information includes first correction information corresponding to a case where a low-density image region follows a high-density image region in a rotational direction of the image bearing member and second correction information corresponding to a case where a high-density image region follows a low-density image region in the rotational direction of the image bearing member.

12. The image forming method according to claim 6,
wherein the correction information includes first correction information corresponding to a case where a low-density image region follows a high-density image region in a rotational direction of the image bearing member and second correction information corresponding to a case where a high-density image region follows a low-density image region in the rotational direction of the image bearing member.

13. An image forming apparatus comprising:
an image bearing member;
a latent-image forming device that forms a latent image onto a surface of the image bearing member;
a developing device that develops the latent image formed on the surface of the image bearing member into a visible image, the developing device having a developer bearing member that is disposed facing the image bearing member in a developing region and that rotates while holding a developer on a surface of the developer bearing member; and
a correcting unit that performs image correction on a region where an image is to be corrected by using correction information set based on a development condition, the region where the image is to be corrected being determined based on a density difference in the image to be formed.
